(19) United States
(12) Patent Application Publication
(10) Pub. No.: US 2002/0144293 A1
(43) Pub. Date: Oct. 3, 2002

(54) Automatic video retriever genie

(75) Inventors: Nevenka Dimitrova, Yorktown Heights, NY (US); Angel Janevski, New York, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/818,303

(22) Filed: Mar. 27, 2001

(51) Int. Cl. H04N 7/173; H04N 7/16

(52) U.S. Cl. 725/133; 725/141; 725/153

(57) ABSTRACT

A method and system for video query processing. Video query processing software is dynamically linked to video content and configured to receive a query keyed to a segment of the video content. The video content is real-time or recorded video content. The software is within a video processing system that may operate in a stand-alone mode or in a service mode. The software is configured to determine an answer to the query and to communicate the answer to a user of the software. The software is coupled to a database that may be utilized to determine the answer to the query. The database may be external to the video processing system and coupled to an Internet web site or to a remote server. Multiple databases may be utilized such that information derived from the multiple databases may be merged to arrive at the answer to the query.

### BACKGROUND OF THE INVENTION

1. Technical Field

The present invention relates generally to a system and method for video query processing, and more particularly, to dynamic context-dependent video query processing.

2. Related Art

Television (TV) users may access an Electronic Program Guide (EPG) through a video processing system to obtain standardized information about a television program as a whole, but cannot use the video processing system to obtain information concerning particularized aspects of the television program. Thus, there is a need for a system and method that enables a TV user to obtain information concerning particularized aspects of a TV program.

### SUMMARY OF THE INVENTION

The present invention provides a video query processing method, comprising:

providing video query processing software;

providing video content;

dynamically linking the software to the video content;

receiving by the software a query keyed to a segment of the video content; and

determining by the software an answer to the query.

The present invention provides a video query processing system, comprising video query processing software dynamically linked to video content and configured to receive a query keyed to a segment of the video content and configured to determine an answer to the query.

The present invention provides a system and method that enables a television (TV) user to obtain information concerning particularized aspects of a TV program.

### BRIEF DESCRIPTION OF THE DRAWINGS

FIG. 1 depicts a block diagram of a video processing architecture, in accordance with embodiments of the present invention.

FIG. 2 depicts dynamic video query processing system in accordance with the video processing architecture of FIG. 1, and in accordance with embodiments of the present invention.

### DETAILED DESCRIPTION OF THE INVENTION

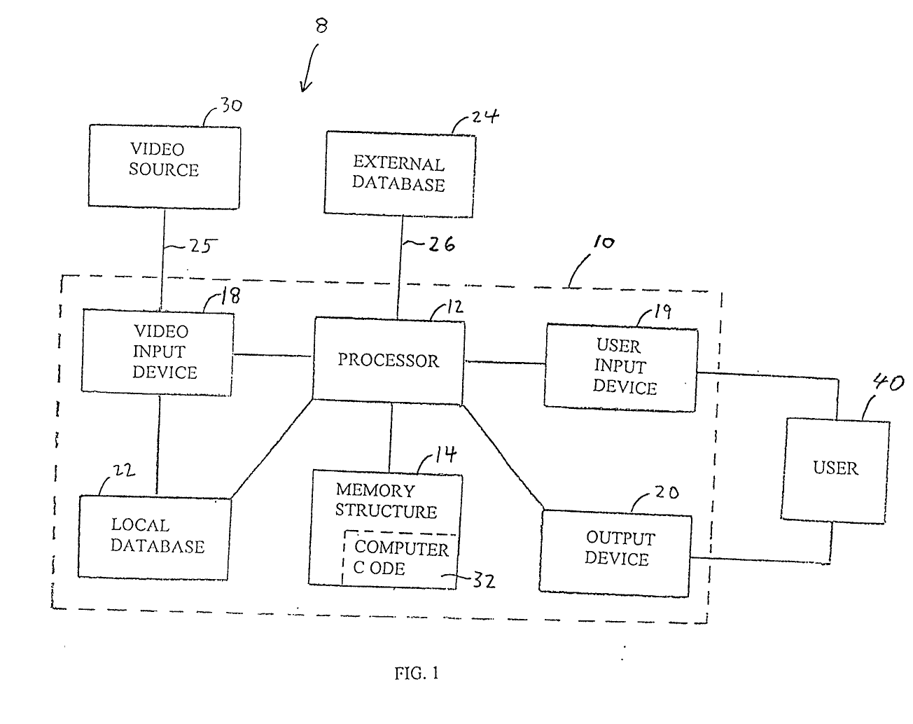

FIG. 1 illustrates a block diagram of a video processing architecture 8, in accordance with embodiments of the present invention. The video processing architecture 8 includes a video processing system (VPS) 10, a video source 30, an external database 24, and a user 40. The VPS 10 includes a processor 12, a memory structure 14 coupled to the processor 12, a local database 22 coupled to the processor 12, video input 18 coupled to the processor 12 and to the local database 22, a user input device 19 coupled to the processor 12, and an output device 20 coupled to the processor 12. The system 10 may represent a computer system (e.g., desktop, laptop, palm-type computer system), a set-top box with a television (TV), etc. The system 10 is not required to be in the particular configuration shown in FIG. 1, but rather may include any storage device having processing power and software that is capable of analyzing video content, capable of receiving video and user input, and implementing interaction with a user. “Video content” includes live video content (i.e., video content received by the system 10 in real time), recorded video content, or future video content (future video content may correlate with a trace of a video program as will be discussed infra).

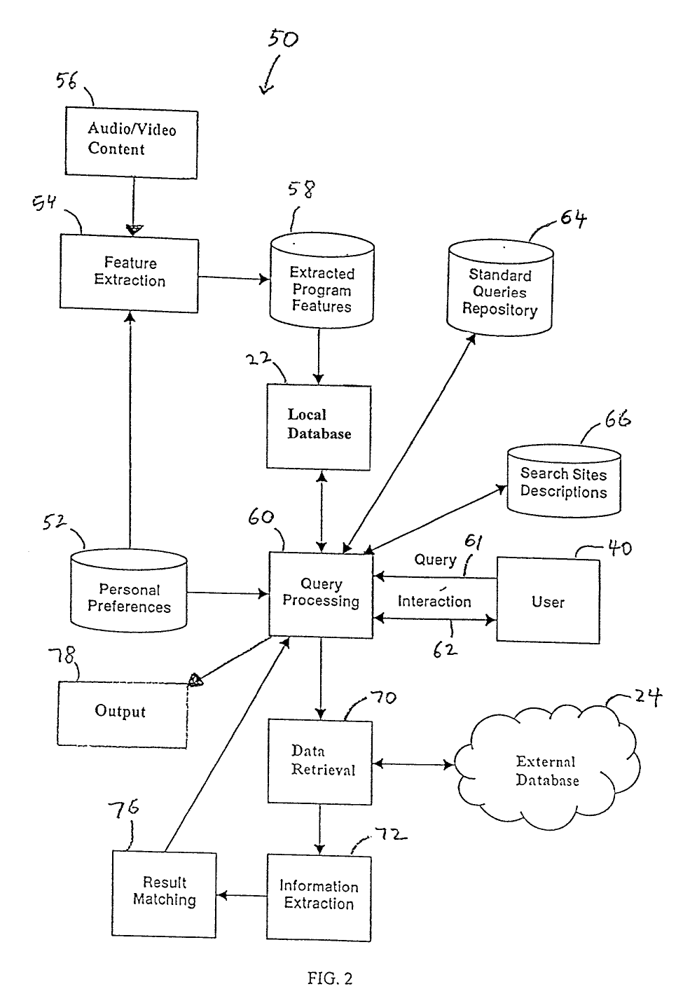

The memory structure 14 includes one or more memory devices or areas therein, which may include temporary memory, permanent memory, and removable memory. Data stored in temporary memory disappears when electrical power to the VPS 10 is disabled. Temporary memory may include, inter alia, random access memory (RAM). Data stored in permanent memory persists when electrical power to the VPS 10 is disabled. Permanent memory may include, inter alia, hard disk memory, optical storage memory, etc. Removable memory may be easily removed from the VPS 10. Removable memory may include, inter alia, a floppy disk or a magnetic tape. The memory structure 14 is configured to store a computer code 32 that implements dynamic query processing algorithms in accordance with the present invention and as described infra in conjunction with FIG. 2. The computer code 32 may be part of a software package that is executed by the processor 12 and may be stored in, inter alia, a RAM within the memory structure 14. Alternatively, the computer code 32 may be encoded in hardware such as on, inter alia, a read only memory (ROM) chip.

The user input device 19 is one or more user input devices, which may include, inter alia, a remote control device, keyboard, mouse, etc. The output device 20 includes one or more of any output device such as, inter alia, an output display (e.g., TV display, a computer monitor, personal digital assistant (PDA) display, mobile phone, etc.), printer, plotter, audio speaker, etc. The output device 20 is any device capable of displaying, or otherwise communicating, data content (i.e., visual data, text data, graphics data, audio data, etc.).

The video input device 18 is any device or mechanism that receives video content (and associated audio and text/or data signals) received from an external video source such as the video source 30, and transmits such video content to the local database 22 or to the processor 12. The video input device 18 may be required to transform the received video content to a viewable format such as from a compressed format (e.g., from a Moving Picture Experts Group (MPEG) format) to a decoded or uncompressed format. The video input device 18 may alternatively receive video content in a viewable format. The video input device 18 may include a physical device but, generally, includes any mechanism for receiving and delivering the video content. The computer code 32 is dynamically linked by the processor 12 to the video input device 18 or to the video content transmitted by the video device 18.

The video source 30 includes one or more sources of video data and associated audio and text data. The video source 30 is a source of a video program receivable by the VPS 10 through a communication medium or path 25 (e.g., television cable lines). The video source 30 may include, inter alia, a television (TV) broadcasting system, a TV satellite system, an Internet web site, a local device (e.g., VHS tape player, DVD player), etc. The video source 30 may transmit, inter alia, a TV program and an Electronic Program Guide (EPG) or a present or future alternative to an EPG, to the VPS 10 through the video input device 18. The EPG has many fields of information (typically more than 100 fields) that describes attributes of TV programs (e.g. for a movie: name of producer, names of actors, summary of contents, etc.). While embodiments of the present invention are directed to TV programs, the scope of the present invention includes any video program that may be communicated to a user from the video source 30 into the VPS 10. Thus, the video source 30 may also include an Internet web site that broadcasts a video program over the Internet, wherein such Internet-broadcasted program may be received by the VPS 10 through any communication medium or path 25 that is technologically available (e.g., telephone lines, TV cable lines, etc.).

The local database 22 comprises one or more databases, data files, or other repositories of data that is stored locally within the VPS 10. The local database 22 includes video data, and associated audio and text data, obtained or derived from the video source 30. Thus, the local database 22 may comprise video data, and associated audio and text data, relating to one or more TV programs, as well as EPG data or a present or future alternative to EPG data associated with such TV programs. The local database 22 also includes other types of data that is needed to process user queries as will be discussed infra in conjunction with FIG. 2. While FIG. 1 shows the local database 22 as being distinct from the memory structure 14 and as being linked or coupled to the memory structure 14, part or all of the local database 22 may alternatively be located within the memory structure 14.

The external database 24 includes any database structure or system, and associated processing software, that is external (i.e., remote) to the VPS 10. The external database 24 communicates with the processor 12 over a communication medium or path 26, which may include, inter alia, telephone lines, TV cable, etc. The external database 24 may comprise, be comprised by, or be coupled to, inter alia, an external server having a database that includes pertinent video data, the Internet with associated web sites and web pages, or an external computer with a database or data files that includes pertinent video data. “Pertinent video data” includes data that is, or may be, directly or indirectly related to video data transmitted from the source 30. The external database 24 may include information of any kind (e.g., a TV program) that relates to video content. As an example, the external database 24 may include specialized information relating to a particular subject area or to a TV program genre. As another example, the external database 24 may include a summary of one or more video programs. Developing a video program summary may be accomplished in any manner known to one of ordinary skill in the art or by using transcript data derived from text, audio, or audio-visual data of the video program as disclosed in: (1) the U.S. patent application Ser. No. 09/747,107 filed Dec. 21, 2000, entitled SYSTEM AND METHOD FOR PROVIDING A MULTIMEDIA SUMMARY OF A VIDEO PROGRAM, and (2) the U.S. patent application Ser. No. 09/712,681 filed Nov. 14, 2000, entitled METHOD AND APPARATUS FOR THE SUMMARIZATION AND INDEXING OF VIDEO PROGRAMS USING TRANSCRIPT INFORMATION, both assigned to the to the assignee of the present invention and incorporated by reference herein.

FIG. 1 also shows a user 40, who may communicate with the VPS 10 through the user input device 19 and the output device 20.

The present invention is directed to dynamic processing of a query (i.e., a question) made by the user 40 in real time while watching a TV program, or otherwise cognitively receiving video data (and associated audio and text data), transmitted from the source 30. The user 40 may ask questions at a granularity level of the whole TV program (“program-level” questions) or at a program segment level in relation to the program segment being watched (“segment-level” questions). A “segment” of video content (e.g., a TV program) is a continuous portion or subset time interval of the video content. If the video content comprises N frames wherein N>1, then a segment of such video content is a continuous set of M frames of the N frames wherein M<N. Segment-level questions and segment-level information typically relate to the context of the segment being viewed (“local context”). In contrast, program-level questions relate to the program as a whole (“global context”).

As an illustration, consider the user 40 to be watching a movie on TV. Examples of a program-level questions that the user 40 might ask include: “What is the name of the movie?”, “Who directed the movie?”, and “At what time does the movie end?” Note that the preceding program-level questions have global context only and do not have local context. Examples of a segment-level questions that the user 40 might ask include: “What is the name of the actor appearing on the screen right now?”, “In what city is the current scene located?”, and “Who composed the music that is playing in the background?” Note that the preceding segment-level questions are at the segment level and thus have local context, since the meaning of the questions depend on the particular program segment being dynamically viewed. Definitionally, a question is considered to have “local context” if its meaning depend on the particular program segment being dynamically viewed. Thus, a segment-level question has local context, and a program-level question has global context only and does not have local context. Also, a query or question is said to be “keyed to a segment” of video content (e.g., a TV program) if the query or question has local context with respect to the segment.

As another illustration, if a news program has 20 news stories, then each such news story is a segment having local context. In contrast, the global context relates to the news program as a whole and is not keyed to any particular news story.

The present invention may find answers to a question asked by the user 40 by utilizing the local database 22, the external database 24, or both, depending on the extent to which the question is at the program level or at the segment level. The local database 22 comprises information derived from video data, and associated audio and text data, relating to TV programs transmitted from the video source 30, as well as EPG data associated with such TV programs. The local database 22 may also comprise a specialized database of information that is subject specific at the program level. Thus, the local database 22 has information at the program level. Additionally, the local database 22 may also comprise segment level data that is keyed to preferences of the user 40. Thus, the local database 22 may be used to answer program-level question and, to a limited extent, segment-level questions. The external database 24 may comprise any kind of database and may therefore include information at both the program level and the segment level. As an example, the external database 24 may include the Internet with a virtually limitless field of free web sites that encompass data of all kinds and are readily available to the processor 12 of the VPS 10. Additionally, the external database 24 may include other Internet web sites that charge a fee for user access. In addition, the external database 24 may include servers and remote computers of all types may be accessed by the VPS 10 if such access via the communication medium or path 26 has been authorized. Definitionally, the VPS 10 is said to be operating in a “stand-alone mode” if the external database 24 is limited to the Internet, and in a “service mode” if the external database 24 has access to a database other than the Internet (e.g., access to a database of a remote server).

FIG. 2 depicts a dynamic video query processing system 50 in accordance with the video processing architecture 8 of FIG. 1, and in accordance with embodiments of the present invention. In FIG. 2, the dynamic video query processing system 50 includes a query processing 60 that is part of the computer code 32 in the memory structure 14 of FIG. 1. In addition, FIG. 2 comprises query processing software that includes the query processing 60 and other software in FIG. 2 (e.g., feature extraction 54) as will be described infra. The query processing 60 shown in FIG. 2, as well as any other software within the computer code 32 shown in FIG. 1, is executed by the processor 12 in FIG. 1. The query processing 60 is dynamically linked by the processor 12 to the video content, and associated audio and text, that is received by the video input device 18 of the VPS 10 (see FIG. 1). Being “dynamically linked” means being able to monitor (or otherwise interact with) the video content, and associated audio and text, in real time as such video content is received by the video input device 18 of the VPS 10. As depicted in FIG. 2, the query processing 60 plays a central role in the dynamic video query processing system 50. The query processing 60 receives and processes query input from the user 40, finds answers to program-level queries, finds answers to segment-level queries, and provides answers to the queries in the form of output, as explained next.

The query processing 60 receives query input 61 from the user 40 and may receive either canned questions or unbounded questions from the user 40. A canned question may be, inter alia: a predetermined generic question stored in a standard queries repository 64 that is part of the local database 22; derived from video content that is dynamically received by the video input device 18 from the video source 30 (see FIG. 1) and may be subsequently stored in the local database 22; or encoded in query processing software within the query processing 60. It is desirable for the source of the canned question to be transparent to the user 40.

Canned questions are genre dependent, so that canned questions for sports programs differ from canned questions for news programs. Canned questions may exploit the genre dependence by being organized in a directory tree structure (e.g., /home/sports/football/“ How many passing yards has this quarterback made this year?”; /home/sports/baseball/” How many home runs has this player hit this year?”; /home/movies/“ Has this actor ever won an Academy Award?”; etc.). Any directory tree structure that could be formulated by a person of ordinary skill in the art could be used. For example, “home/sports/football/queries” could denote a file that includes each of the preceding questions in a separate record of the file or as a separate word within a single record of the file.

The canned questions may include program-level questions and segment-level questions. The segment-level canned questions are transient; i.e., they come and go as the program evolves and they become relevant at a given point in the program only in the context of what is happening at that point in the program. For example, in a football game just after a team scores a field goal, a timely canned question might be: “How many other field goals has the field goal kicker kicked during the present season?”

An unbounded question is a free-form question that is not a canned question. The final form of a query must include a canned question. Accordingly, the query processing 60 translates each unbounded question received from the user 40 into one or more standard queries in accordance with technology known to one of ordinary skill in the art, and processing the answer if necessary. To illustrate, assume that the user 40 is watching a football game between team A and team B, and transmits the following example question to the query processing 60: “When is the last time team A won over team B?”. The example question could be one of the canned questions in the standard queries repository 64, but could also be a free-form question. If a free-form question, the example question is converted by the query processing 60 into the following canned question: “When did team A play team B and what were the final scores?” After this canned question is answered, the query processing 60 examines the final scores and selects the latest game when the score of team A exceeded the score of team B.

If the user 40 asks a canned question or an unbounded question, the question may be ambiguous and require feedback interaction 62 from the user 40. To illustrate, assume that the user 40 is watching a “Star Trek” movie, wherein a scene being watched shows two actors Captain Picard and Number One, and the user 40 chooses (e.g., by pressing a query button of a remote control of the user input device 19 of FIG. 1) the following canned question: “What other movies has this actor been in?” Here, the canned question is ambiguous since the canned question does not allow particularization to a single actor. Accordingly, the query processing 60 may ask the user 40 through the feedback interaction 62 (e.g., by a pop-up message on an output device 20 in FIG. 1) “Is the actor Captain Picard or Number One?” Once the user 40 makes a choice (e.g., by remote control or speaking the choice) such as Captain Picard, the query processing 60 can recast the query in the following unambiguous form: “What other movies has the actor playing Captain Picard been in?” The recast question can be further processed using the external database 24 to answer the recast question. The preceding example at the segment level of a Star Trek movie illustrates that a canned question having local context requires segment-level input to cast the question in proper form for further processing. Such a canned question requiring segment-level input is called an “indefinite question” and is considered to be in “indefinite form.” After such an indefinite question has been recast in proper form through incorporation of segment-level input, the recast question is called a “definite question” and is in “definite form.”

The user 40 communicates and interacts with the query processing 60 by use of the user input device 20 (see FIG. 1) which may include, inter alia, a remote control device, a computer keyboard or mouse, the voice of the user 40 using voice recognition software, etc.

In relation to FIG. 2, once a query by a user 40 is in proper form for further processing, the query processing 60 uses the local database 22, the external database 24, or both, to determine an answer to the query and outputs the answer in the output 78 which corresponds to the output device 20 of FIG. 1. In order to use the local database 22 for answering a program-level question, the query processing 60 makes use of feature extraction 54 software. The feature extraction 54 software dynamically extracts program-level features 58 and places such extracted features in the local database 22 for use by the query processing 60 for answering program-level queries by the user 40. As stated supra, part or all of the local database 22 may exist in the memory structure 14 (see FIG. 1). In particular, the extracted program-level features 58 may be placed in transient memory such as in a RAM buffer so as to be made readily available to the query processing 60 when needed.

“Features” may comprise signal-level data or metadata that is derived from the video source 30 (see FIG. 1). The signal-level data features may relate to, inter alia, color, shape, or texture. The metadata features may include, inter alia, EPG data or a present or future alternative to EPG data associated with one or more TV programs. Metadata features may include any program-level information such as program genre (e.g., news, sports, movie, etc.), program title, cast, TV channel, time slot, etc. The signal-level features could be retained in a signal-level format, or alternatively could be encoded as metadata.

The signal-level features or metadata features are extracted in accordance with any algorithms of the feature extraction 54 software. Such algorithms may be in accordance with user 40 personal preferences 52 (e.g., program genre, a particular actor, a particular football team, particular time slots, etc.) that have been stored in the local database 22. For example, a user 40's favorite team can be used to focus the feature extraction 54 along particular lines. Personal preferences of the user 40 may be generated in accordance with user 40 input or user 40 viewing history. The user 40 personal preferences 52 may also be used to customize the canned questions in the standard queries repositories 64. Feature extraction 54, which occurs dynamically and automatically in the background, is not subject to user 40 discretion but may be influenced by user 40 personal preferences as stated supra. Developing personal preferences of the user 40 may be accomplished in any manner known to one of ordinary skill in the art or as disclosed in: (1) the U.S. patent application Ser. No. 09/466,406 filed Dec. 17, 1999, entitled METHOD AND APPARATUS FOR RECOMMENDING TELEVISION PROGRAMMING USING DECISION TREES, and (2) the U.S. patent application Ser. No. 09/666,401 filed Sep. 20, 2000, entitled METHOD AND APPARATUS FOR GENERATING SCORES USING IMPLICIT AND EXPLICIT VIEWING PREFERENCES, both assigned to the to the assignee of the present invention and incorporated by reference herein.

In addition to extracting features from EPG data or a present or future alternative to EPG data, the feature extraction 54 may extract features from video data, and associated audio and text data, of a TV program and, in particular, from visual portions, closed caption text, faces using face detection software, audio content, etc. Feature extraction 54 may be implemented in any manner known to one of ordinary skill in the art or as disclosed in the U.S. patent application Ser. No. 09/442,960 filed Nov. 18, 1999, entitled METHOD AND APPARATUS FOR AUDIO/DATA/VISUAL INFORMATION SELECTION, assigned to the assignee of the present invention and incorporated by reference herein. Additional pertinent references on feature extraction include: (1) N. Dimitrova, T. McGee, L. Agnihotri, S. Dagtas, and R. Jasinschi, On Selective Video Content Analysis and Filtering, presented at SPIE Conference on Image and Video Databases, San Jose, 2000; and (2) N. Dimitrova, L. Agnihotri, C. Dorai, and R. Bolle, MPEG-7 Videotext Description Scheme for Superimposed Text in Images and Video, Signal Processing: Image Communication Journal, Volume 16, pp. 137-155, September 2000.

Feature extraction 54 in conjunction with the local database 22 may be used to answer program-level queries, or segment-level queries keyed to user preferences. However, the external database 24 may also be used to find answers to program-level queries. In addition, the external database 24 may be used to find answers to segment-level queries. Thus, the following discussion focuses on how the query processing 60 uses the external database 24 to find answers to either program-level queries or segment-level queries made by the user 40.

Pointers to external databases which are available to the query processing 60 are stored in the search site descriptions 66 database or repository, which is part of the local database 22 or is encoded within the software of the query processing 60 itself These pointers may be subject-specific in accordance with subjects that relate to the canned questions in the standard queries repository 64. These pointers may be organized within a directory tree structure. For example, a pointer may be a pointer that is a Uniform Resource Locator (URL) of an Internet website. To illustrate, a news database may appear as follows in the search site descriptions 66 database or repository as /home/news/”http://www.cnn.com”, while a football database may appear as follows in the search site descriptions 66 database or repository as /home/sports.football/”http://www.nfl.com”. Any directory tree structure that could be formulated by a person of ordinary skill in the art could be used. For example, “home/news/URL” could denote a file in the search site descriptions 66 database or repository that includes pointers to news websites (e.g., “http://www.cnn.com”, “http://www.abc.com”, etc.), such that each such pointer is a separate record of the file or is a separate word within a single record of the file. Similarly, “home/sports/football/URL” could denote a file in the search site descriptions database or repository that includes pointers to football websites (e.g., “http://www.nfl.com”, “http://www.football.com”, etc.), such that each such pointer is a separate record of the file or is a separate word within a single record of the file.

The search site descriptions 66 database or repository may include pointers to any available external database 24 or information source that can be communicated with over the communication medium or path 26 (see FIG. 1). Such external databases 24 or information sources may include external servers or remote computers that have data or information for subjects associated with canned questions in the standard queries repository 64. Additionally, the external databases may include specialized servers or remote computers which have data or information on only specialized subjects (e.g., movies, jazz, sports, etc.) that is obtained from other databases or information sources. Selection of a pointer to appropriate databases for answering the question asked by the user 40 may involve linking the subject content of the question with subject content of other information sources and may be implemented in any manner known to one of ordinary skill in the art or as disclosed in the U.S. patent application Ser. No. 09/351,086 filed Jul. 9, 1999, entitled METHOD AND APPARATUS FOR LINKING A VIDEO SEGMENT TO ANOTHER VIDEO SEGMENT OR INFORMATION SOURCE, assigned to the assignee of the present invention and incorporated by reference herein.

Once the query processing 60 has identified a particular external database pointer in the search site descriptions 66 database or repository for finding an answer to the query of the user 40, the query processing 60 uses the pointer to link with the particular external database 24 and retrieves data 70 from the particular external database 24, wherein the retrieved data 70 relates to the query. The query processing 60 may link to a subject-specific destination at the particular external database 24 (e.g., a specific Internet web page that potentially includes data or information relating to the query) or to a search engine destination (e.g., at the particular external database, such as the Internet search engine website http://www.altavista.com, coupled with search parameters such as a question for a natural language search or a logical expression for a keyword-based search). As an example, the natural language question “Did actor Clark Gable ever win an Academy Award?” may be asked of a search engine, or the same question may be answered by a keyword search based on the logical expression: “Clark Gable” AND “Academy Award”. The retrieved data 70 may be in any form, such as in the form of one or more web pages from an Internet website, or in the form of one or more files, documents, spreadsheets, graphical images, etc. from a remote server.

The data communicated between the query processing 60 and the external server is in a data format that the external server 24 recognizes, such as Extensible Markup Language (XML) universal format for structured documents and data on the Web, Joint Photographic Experts Group (JPEG) standards for continuous tone image coding, TV Anytime Forum standards to enable audio-visual and other services based on mass-market high volume digital storage, etc. Substantively, the external server 24 sends the retrieved data 70 as strings, numerical data, graphics, etc. to provide included information (e.g., name of an actor, description of a scene, etc.) in response to a request by the query processing 60.

Once data generally relating to the query is data-retrieved 70 at the external database 24, an information extraction 72 extracts the specific information from the retrieved data that facilitates actually answering the query. The information extraction 72 implements an information filtration process that “separates the wheat from the chaff” i.e., discards the irrelevant information from the data retrieved 70, and retains the relevant information, from the data retrieved 70. The information extraction 72 may be performed at the site of the external database if the external database has the required processing capability. Otherwise or alternatively, the information extraction 72 may be performed as part of the query processing 60 or the computer code 32 (see FIG. 1). Then the information extracted 72 is further processed by the external database or the query processing 60, if necessary, to arrive at the final answer to the query. An example of such further processing is result matching 76. Note that information extraction 72 for external databases 24 is similar to extracted program features 58 for the local database 22. Information extraction may be implemented in any manner known to one of ordinary skill in the art.

Information extraction 72 rules are dynamically constructed in real time as the query is processed. As an example, consider a generic information extraction rule about extracting celebrity information (e.g., about an actor, politician, athlete, etc.). During a talk show, multiple celebrity types (i.e., actor, politician, athlete, etc.) can be guests on the talk show. The information extraction 72 extracts information relating to who the particular guest is in the pertinent segment of the talk show. Thus, the name of the particular guest is a parameter of the information extraction task and becomes part of the query itself. The information extraction task is particularized to seek information about the particular guest, and seek a specific set of web sites or databases relating to the specific guest. The local context information (i.e., the particular guest) is a consequence of the segment-level architecture.

An example of result matching 76 illustrates that answering a query may require use of multiple sources of information, followed by merging the multiple source result data into a single answer. Multiple sources may include, inter alia, a plurality of external sources, a local source and one or more external sources, etc. For example, the question “How many movies has this actor played in?” may require use of two external sources: source A and source B. If names of 10 movies are returned from source A and names of 5 movies are returned from source B, and if 3 movies are common to the returned movie names from source A and source B, then the query processing 60 matches the source-A and source-B movie names against each other and arrives at 12 distinct movie names.

After the query processing 60 determines an answer to the question asked by the user 40, the query processing 60 communicates the answer to the user 40 via the output 78 at one or more output device 20 (see FIG. 1). The output 78 may be in any form and may be delivered to the user 40 by any method of delivering a message (e.g., E-mail). Examples of the one or more output devices 20 to which the output 78 may be delivered include: personal digital assistant, mobile phone, TV display, a computer monitor, printer, plotter, audio speaker, etc. The output 78 may be communicated to the user 40 by any method of delivering a message (e.g., E-mail). The particular output device 20 utilized for communicating the answer to the user 40 may be hard-coded into the query processing 60 or selected by the user 40 via the feedback interaction 62.

The query processing 60 includes logic to account for the fact that a given database may not return the information requested of it by the query processing 60. For example, if a specialized server fails to provide the requested information, then the query processing 60 may go to an Internet web site to seek the same requested information. Additionally, user 40 preferences could be used to determine which external sources to search, or not to search. For example, the user 40 could indicate that searching for football questions should include Internet website “http://www.nfl.com”, but should exclude Internet website “http://espn.go.com/abcsports/mnf”.

While the description supra herein considered dynamic, real-time user query processing, the scope of the present invention also includes user query processing for video content (e.g., TV programs) that occurred in the past or will occur in the future. The user query processing of the present invention applies to past video content that had been recorded, such as on a VHS tape player or a personal video recorder in a set-top box, since such video content, when played back, simulates real-time viewing for the purpose of processing user 40 queries. Alternatively, a trace of an TV program (e.g., selected frames or images, selected text, selected audio, etc.) could be stored (as opposed to storing the whole TV program itself) on a VHS tape player or a personal video recorder in a set-top box, and a playback of the trace could trigger the user 40 to ask questions about the TV program that the trace is associated with. Additionally, the user query processing 60 of the present invention also applies to the future video content (e.g., TV programs) if there is a trace of the future TV content that the user 40 could view.

While the description supra herein characterized the local database 22 of FIG. 1 as being capable of supporting program-level queries, it is nonetheless within the scope of the present invention for the local database 22 to have a capability of supporting segment-level queries as well (e.g., segment-level queries that relate to user preferences).

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

We claim:

1. A video query processing method, comprising:
providing video query processing software;
providing video content;
dynamically linking the software to the video content;
receiving by the software a query keyed to a segment of the video content; and
determining by the software an answer to the query.

2. The method of claim 1, wherein the software is within a video processing system.

3. The method of claim 2, wherein the video processing system is operating in a stand-alone mode.

4. The method of claim 2, wherein the video processing system is operating in a service mode.

5. The method of claim 1, wherein providing video content includes providing video content in real time.

6. The method of claim 1, wherein providing video content includes providing recorded video content.

7. The method of claim 1, wherein the determining comprises receiving information by the software, wherein the information is derived from a database, and wherein the information answers the query.

8. The method of claim 7, wherein receiving information includes:
receiving data from the database, wherein the data includes the information; and
extracting the information from the data.

9. The method of claim 7, wherein receiving information includes:
finding data in the database, wherein the data includes the information; and
extracting the information from the data at the database;
sending the information to the software.

10. The method of claim 7, further comprising identifying the database by a pointer located in a search site descriptions repository.

11. The method of claim 7, wherein the software is within a video processing system, and wherein the database is external to the video processing system.

12. The method of claim 11, wherein the database is coupled to an Internet web site.

13. The method of claim 11, wherein the database is coupled to a remote server.

14. The method of claim 1, wherein providing video content includes providing the dynamic video content to a user of the video query processing method, and wherein receiving the query includes communicating the query to the software by the user.

15. The method of claim 14, further comprising communicating the answer to the user.

16. The method of claim 1, wherein the determining comprises:
receiving by the software information derived from each database of a plurality of databases, wherein each database is external to the video processing system, and wherein the information derived from each database partially answers the query; and
merging the information derived from each database to arrive at the answer.

17. The method of claim 16, wherein receiving information includes:
receiving data from each database, wherein the data received from each database includes the information derived from each database; and
extracting the information derived from each database from the data of each database.

18. The method of claim 16, wherein receiving information includes:
finding data in each database, wherein the data in each database includes the information derived from each database;
extracting the information derived from each database from the data in each database, wherein the extracting is executed at each database; and
sending the information derived from each database to the software.

19. The method of claim 1, wherein the query received by the software is a canned query.

20. The method of claim 19, wherein the canned query is a function of a genre of the video content.

21. The method of claim 1, wherein the query received by the software is an unbounded query, and further comprising deriving at least one canned query from the unbounded query.

22. The method of claim 1, wherein the query received by the software is in indefinite form, and further comprising recasting the received query in definite form.

23. The method of claim 1, further comprising:
receiving by the software a program-level question in relation to the video content; and
ascertaining by the software an answer to the question.

24. The method of claim 23, further comprising extracting features from the video content, wherein the ascertaining includes utilizing the extracted features to answer to the question.

25. The method of claim 24, further comprising storing the extracted features in transient memory prior to utilizing the extracted features to answer the question.

26. The method of claim 24, wherein extracting features includes taking into account preferences of a user of the query processing method.

27. The method of claim 24, wherein extracting features from the video content includes extracting features from at least one of a video program of the video content and an electronic program guide of the video content.

28. A video query processing system, comprising video query processing software dynamically linked to video content and configured to receive a query keyed to a segment of the video content and configured to determine an answer to the query.

29. The system of claim 28, wherein the software is within a video processing system.

30. The system of claim 29, wherein the video processing system is operating in a stand-alone mode.

31. The system of claim 29, wherein the video processing system is operating in a service mode.

32. The system of claim 28, wherein the video content includes real-time video content.

33. The system of claim 28, wherein the video content includes recorded video content.

34. The system of claim 28, further comprising a database, wherein the software is configured to determine the answer by receiving information that is derived from the database, and wherein the information answers the query.

35. The system of claim 34, wherein the software is configured to receive data from the database, wherein the data includes the information, and wherein the software is configured to extract the information from the data.

36. The system of claim 34, wherein data in the database includes the information, wherein the information is extracted at the database from the data, and wherein the information so extracted is sent to the software.

37. The system of claim 34, further comprising a search site descriptions repository that is coupled to the software, wherein the search site descriptions repository includes a pointer that identifies the database.

38. The system of claim 34, wherein the software is within a video processing system, and wherein the database is external to the video processing system.

39. The system of claim 38, wherein the database is coupled to an Internet web site.

40. The system of claim 38, wherein the database is coupled to a remote server.

41. The system of claim 28, wherein the software is configured to receive the query from a user of the video query processing system.

42. The system of claim 41, wherein the software is configured to communicate the answer to the user.

43. The system of claim 28, further comprising a plurality of databases, wherein the software is configured to receive information derived from each database of the plurality of databases, wherein each database is external to the VPS, wherein the information derived from each database partially answers the query, and wherein the system is configured to merge the information derived from each database to arrive at the answer.

44. The system of claim 43, wherein the software is configured to receive data from each database, wherein the data received from each database includes the information derived from each database, and wherein the software is configured to extract the information derived from each database from the data of each database.

45. The system of claim 43, wherein the data in each database includes the information derived from each database, wherein the information is extracted at each database from the data in each database, and wherein the information so extracted is sent to the software.

46. The system of claim 28, wherein the query is a canned query.

47. The system of claim 46, wherein the canned query is a function of a genre of the video content.

48. The system of claim 28, wherein the query is an unbounded query, and wherein the software is configured to derive at least one canned query from the unbounded query.

49. The system of claim 28, wherein the query is in indefinite form, and wherein the software is configured to recast the query in definite form.

50. The system of claim 28, wherein the software is configured to receive a program-level question in relation to the video content and to ascertain an answer to the question.

51. The system of claim 50, wherein the software is configured to extract features from the video content, wherein to ascertain an answer to the question includes to utilize the extracted features to answer the question.

52. The system of claim 51, wherein the software is configured to store the extracted features in transient memory.

53. The system of claim 51, wherein to extract features includes to take into account preferences of a user of the query processing system.

54. The system of claim 51, wherein to extract features from the video content includes to extract features from at least one of a video program of the video content and an electronic program guide of the video content.

55. A video processing architecture, comprising a video processing system, wherein the video processing system includes:
a processor;
a memory structure coupled to the processor, wherein the memory structure includes a computer code, wherein the computer code includes video query software configured to be dynamically linked to video content and configured to receive a query keyed to a segment of the video content and configured to determine an answer to the query;
a local database coupled to the processor;
a video input device coupled to the processor and to the local database;
a user input device coupled to the processor; and
an output device coupled to the processor.

56. The video processing architecture of claim 55, further comprising an external database coupled to the software, wherein the video query software is configured to utilize the external database to determine the answer to the query.

57. The video processing architecture of claim 55, further comprising a video source, wherein the video processing architecture is configured to enable the video source to transmit the video content to the video processing system.

58. The video processing architecture of claim 55, wherein the software is configured to receive the query from a user of the software.

59. A computer program product comprising a computer usable medium having a computer readable computer code embedded therein, wherein the computer code comprises video query processing software dynamically linked to video content and configured to receive a query keyed to a segment of the video content and configured to determine an answer to the query.
